(19) United States
(12) Patent Application Publication
(10) Pub. No.: US 2002/0145874 A1
(43) Pub. Date: Oct. 10, 2002

(54) Lamp assembly with led stimulation of phospher

(76) Inventor: John H. Kahl, Valencia, CA (US)

Correspondence Address: Edward E. Roberts, P.O. Box 3206, Dana Point, CA, 92629, US

(21) Appl. No.: 09/827,286

(22) Filed: Apr. 6, 2001

(51) Int. Cl. F21K 2/00

(52) U.S. Cl. 362/260; 362/84; 362/293; 362/255; 362/800

(57) ABSTRACT

A surface mount lamp assembly for mounting to a substrate having a body formed, such as by molding, of a silicone rubber mixed with phosphor. The body has a cavity formed therein for receiving a blue or ultra violet (UV) output light emitting diode (LED), and is typically a translucent combination of silicone rubber and a desired amount of phosphor mixed therein Luminescent output is achieved upon stimulation by short wavelength energy of the diode acting upon the body to function as a frequency converter up-shifting the blue light into longer wavelengths. The silicone rubber/phosphor mixture also acts to mix the blue light with the longer wavelength light to result in a light, typically a white color light, which can be shifted in color hue depending upon the quantity and type of phosphor mixed into the silicone rubber.

In one embodiment the body has an enlarged base with a peripheral generally planar lip providing a pick-up surface for vacuum type tools. The base may be generally rectangular in cross-section with opposing sides of the peripheral flattened to provide indexing surfaces for mechanical orientation and handling devices, and include V-shaped cut outs on opposite edges for enabling protrusion of the leads into the slots so formed, thus providing protection for the leads during handling.

### RELATED APPLICATION

The applicant is a co-inventor of the invention described and claimed in U.S. Pat. No. 6,086,225 issued Jul. 11, 2000, and entitled “SURFACE MOUNT LAMP ASSEMBLY”.

### BACKGROUND OF THE INVENTION

1. Field of the Invention

The invention relates to miniature light emitting devices, and more particularly to devices using a blue light emitting diode to stimulate a phosphor mixed translucent silicone rubber body resulting in a light that can be shifted into color hue by the quantity and type of phosphor mixed into and held in suspension by the silicone rubber.

2. Description of the Prior Art

In modern printed circuit board (PCB) construction, surface mount technology has moved to the forefront in mass production of electronic devices, components and sub-assemblies. The use of surface mount devices (SMD) has greatly expanded in the automotive industry to reduce cost and to enhance reliability over the incandescent lamps traditionally used for such applications as instruments and radios. Such an SMD is shown and described in the above mentioned related patent

However, prior art devices have been hindered by the lack of suitable “white light” sources. The development of the short wavelength emitting blue light emitting diode (LED) with added phosphor has created a new generation of reliable white light emitting devices. Methods of producing “white” light from a blue LED is well understood as disclosed for instance in the European Patent application EP 0 936 682 A1, Shimizu, et al., filed Jul. 29, 1997. The application discloses a semiconductor source with a phosphor to emit light at longer wavelengths.

U.S. Pat. No. 5,962,971 issued to Chen on Oct. 5, 1999 discloses the application of a phosphor to the outside of an LED envelope wherein 3 mm and 5 mm LEDs are described as having an additional resin layers added externally to encapsulate a phosphor to produce “white light”.

A surface mount LED with phosphor is disclosed by Japanese JP11031845, Shimizu, et al., application Ser. No. 09188,745 filed Jul. 14, 1999, in which a phosphor is sprayed onto a resin layer. However, this type of device exhibits limitations in its adaptability to light pipes, and because of its low profile utilization of its light is difficult in many applications due to obstructions from taller adjacent components.

U.S. Pat. No. 6,086,225 issued Jul. 11, 2000 to Kahl, et al. discloses a translucent silicone rubber housing with a cavity to accept an incandescent lamp for use as a surface mount lighting device. The silicone housing is pigmented to act as a subtractive filter blocking undesired portions of the spectral energy while passing desired energy to achieve a given color.

U.S. Pat. No. 5,593,223 issued Jan. 14, 1997 to Koizumi, discloses apparatus and means for vacuum pickup of a light emitting element during mounting procedures

Prior art phosphor based LED devices typically have the phosphor attached to the semiconductor die and covered with an encapsulating resin. This method of manufacture makes it difficult to provide different ratios and types of phosphor to produce different colors and hues of light except by using different prefabricated assemblies. Using the silicone/phosphor housing of the present invention, the housing can be made separately from the semiconductor and resin and then assembled as desired with the appropriate LED element.

### SUMMARY AND OBJECTS OF THE INVENTION

The present invention is intended to overcome prior art deficiencies, and to provide unique miniature light emitting devices using a blue, or ultra violet, light emitting diode to stimulate a phosphor mixed translucent silicone rubber body resulting in a light that can be shifted into color hue by the quantity and type of phosphor mixed into the silicone rubber.

According to one embodiment, there is provided a surface mount device for mounting to a substrate, such as a printed circuit board, that utilizes a translucent housing of a silicone rubber/phosphor mix having a blue light emitting diode inserted into a cavity in the housing When stimulated by the short wavelength energy of the light emitting diode (LED), the silicone/phosphor mix acts as a frequency converter to up-shift the blue light into longer wavelengths. This produces a luminescent output, typically a white color light that can be shifted in color hue by the quantity and type of phosphor mixed into the housing.

The housing is designed to provide both the light-converting element and the structural element of the device that encases the LED. The housing has an enlarged generally rectangular in configuration shaped base portion with a peripheral lip and indexing flat sides on opposite sides for facilitating mechanical orientation and handling. Generally V-shaped sections are removed on opposite edges on the long axis thereof for enabling protrusion of the leads into the slots so formed, thus providing protection for the leads during handling The closed portion of the housing has a generally planar surface for enabling vacuum pick-up to facilitate accurate placement of the assembly onto a substrate, such as a printed circuit board (PCB).

An advantage of the invention is providing different colors and hues of light by using various ratios and types of phosphor in the silicone/phosphor housing. This provides variation in manufacture in that the housings can be manufactured of various phosphor types and ratios separately from the LED, and then assembled to produce the desired colors and light hues.

The configuration of the cavity provides that the LED can be inserted with the leads bent into the mounting plane to enable the leads to be utilized for mechanical and electrical bonding to the substrate. The leads are visible through generally V-shaped cutouts in the housing to provide visual inspection for verifying soldering integrity and are of different lengths to provide polarity indication for correct placement of the assembly on the printed circuit board.

According to another embodiment of the invention a silicone rubber/phosphor mix is inserted into a silicone rubber, or elastomer, switch substrate to provide a low profile light source for an illuminated switch typically used in automobile interiors. The silicone/phosphor frequency converting element is formed as an insert into the substrate and then placed over a surface mounted “chip” type light emitting diode that produces light in the blue or ultra violet range.

It is another object of the invention to provide a surface mount lamp assembly using a blue light emitting diode to stimulate a translucent silicone/phosphor mixed housing, the housing acting as a frequency converter thereby up-shifting the blue light into longer wavelengths.

It is yet another object of the invention to provide a surface mount lamp assembly comprising a translucent silicone/phosphor mixed housing containing a blue light emitting diode, the blue light stimulating the housing to act as a frequency converter to up-shift the blue light into longer wavelengths.

It is a further object of the invention to provide a surface mount lamp assembly comprising a translucent silicone/phosphor mixed housing containing a blue light emitting diode, the blue light stimulating the housing to produce a light which can be shifted in color hue determined by the quantity and type of phosphor mix in the housing.

Other objects, features and advantages will become apparent on a reading of the specification when taken in conjunction with the drawings, in which like reference numerals refer to like elements in the several views.

### BRIEF DESCRIPTION OF THE DRAWINGS

FIG. 1 is a side elevational view, partially in section, of a surface mount lamp assembly according to the prior art wherein an incandescent lamp is used;

FIG. 2 is a spectral plot showing the energy distribution of an incandescent lamp compared to that of a typical blue light emitting diode;

FIG. 3 is a side elevational view, partially in section, of a surface mount lamp assembly according to the invention;

FIG. 4 is a top plan view of the lamp assembly invention of FIG. 3;

FIG. 5 is a side elevational view, partially in section, of an alternative of the embodiment of the lamp assembly of FIG. 3;

FIG. 6 is a top plan view of the lamp assembly invention of FIG. 5, FIG. 7 is a side elevational view, partially in section, of lamp assembly of FIG. 3 designed to accept a different LED package;

FIG. 8 is a view of the lamp assembly of the invention adaptable to a light pipe;

FIG. 9 is a side elevational view, partially in section, of the lamp assembly of the invention adaptable for vacuum pickup; and

FIG. 10 is a side elevational view of the lamp assembly of the invention inserted into an elastomer keypad substrate.

### DESCRIPTION OF THE PREFERRED EMBODIMENT

The invention relates to miniature light emitting devices using a blue light emitting diode to stimulate a phosphor mixed translucent silicone rubber body resulting in a light that can be shifted into color hue by the quantity and type of phosphor mixed into and held in suspension in the silicone rubber.

In accordance with the present invention there is disclosed a two-part surface mount assembly formed of a silicone rubber/phosphor mixed translucent housing, or filter, and a miniature light emitting diode inserted into a recess, or cavity in the housing The diode is an industry standard blue, or ultra violet, light emitting diode.

The short wavelength energy of the blue light emitting diode stimulates the housing, or filter, which acts as a frequency converter up-shifting the blue light into longer wavelengths. The mixed silicone/phosphor housing also acts to mix the blue light with the longer wavelength light that the phosphor produces thereby resulting in a light, typically a white color light, which can be shifted into color hue by the quantity and type of phosphor mixed into the silicone rubber

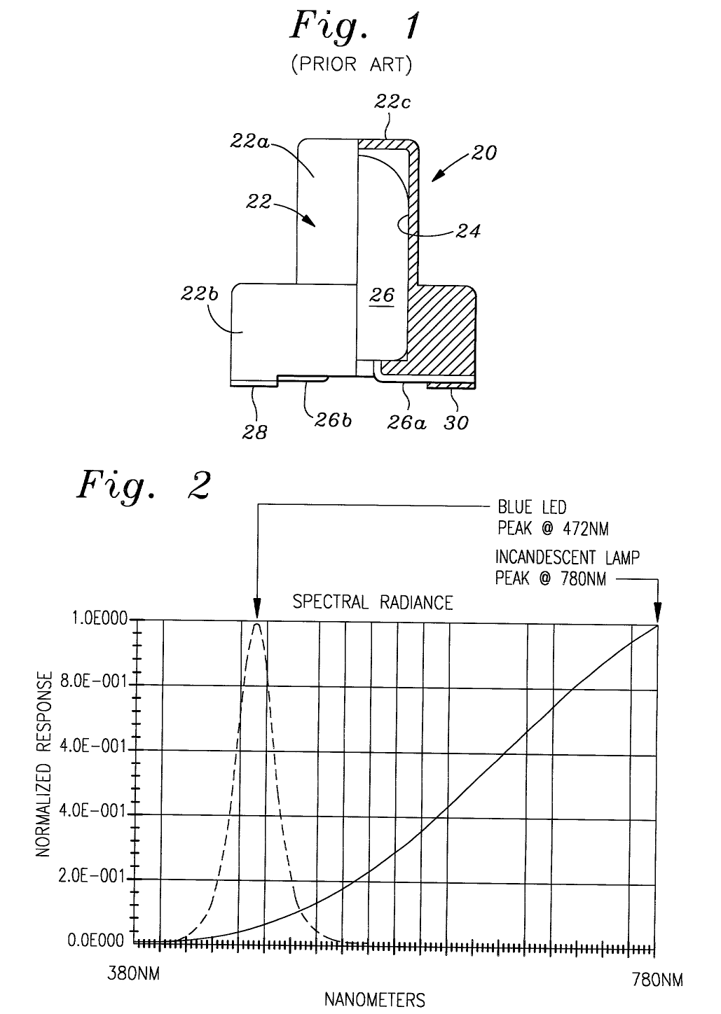

FIG. 1 depicts a prior art surface mount lamp assembly as disclosed in the above-mentioned related U.S. Pat. No. 6,086,225 wherein there is described a translucent silicone rubber housing for an incandescent lamp. The silicone housing is pigmented to act as a subtractive filter blocking undesired portions of the spectral energy while passing desired energy to achieve a given color. The housing is formed with a generally uniform wall thickness for providing substantially uniform light transmission from the incandescent lamp.

As shown, the assembly, generally designated 20, has a lamp housing 22 formed as an inverted cup-shaped member 22a having a generally planar top 22c that serves as a vacuum pick-up area. The housing is integrally formed with an enlarged base portion 22b, generally of an ovoid or rectangular configuration. Although not shown, the base portion 22b has an enlarged flange portion and a pair of oppositely disposed generally V-shaped cut-outs at opposite edges of the flange portion in alignment with the long axis of the oval-shaped flange. An open bottom permits cavity access for insertion of a miniature incandescent lamp

FIG. 2 depicts a spectral plot showing the energy distribution of an incandescent lamp compared to that of a typical blue light emitting diode. The shorter wavelength is needed as commonly understood by Stoke's Law, which states that the wavelength of luminescence stimulated by radiation always surpasses that of the stimulating radiation. This also excludes light emitting diodes with long wavelengths, such as in the red region, from being used Thus, as stated above, the prior art surface mount incandescent lamp assembly is not suitable as a short wavelength stimulator due to its lack of energy at shorter wavelengths.

In accordance with an aspect of the invention there is provided a unique lamp assembly for mounting to a substrate that is suitable as a short wavelength stimulator. The assembly utilizes a blue light emitting diode to stimulate a silicone/phosphor mixed translucent housing to provide a light that can be shifted in color hue depending upon the quantity and type of phosphor mixed into the housing.

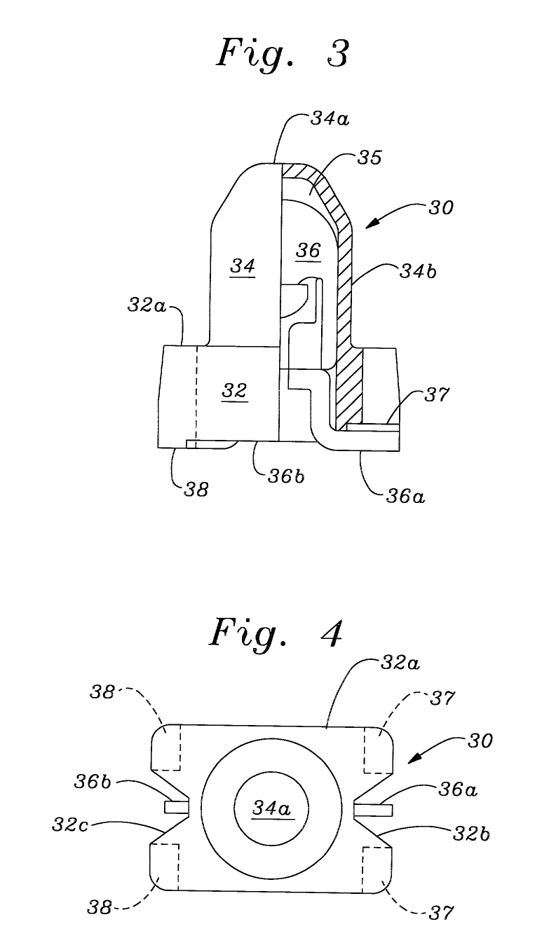

FIG. 3 depicts, in a side elevational view, partially in section, and FIG. 4 depicts, in a top plan view, the surface mount lamp assembly according to the invention. In these figures, it is seen that the assembly 30 of the present invention is similar in construction to that of the prior art shown in FIG. 1. The unique difference is that in the assembly 30, housing portion 34 and the base portion 32 are formed of a single molding comprised of a translucent silicone rubber/phosphor mix, and the lamp is a blue light emitting diode (LED). As further described below, the housing portion 34 is of an inverted truncated cup-shaped configuration and the base portion 32 is enlarged from the housing 34. Base 32 is generally rectangular, or oblong, in configuration with a peripheral generally planar lip surface 32a that serves as a vacuum pick-up surface for facilitating accurate placement of the assembly onto a substrate. The one piece combination of housing 34 and base 32 has a recess, or cavity, 35 designed to accept diode 36, which can be an industry standard blue, or ultra violet, light emitting diode.

Assembly 30 is also uniquely designed to provide not only the structural element of the device, but also the light-converting element for the encased LED 36. The body shape of the assembly allows good coupling of the light output to the device being illuminated while allowing for easy pickup by the automated placement equipment. It is also well suited for delivery to the placement equipment in industry standard carrier tape.

As seen in FIG. 3, the filter housing 34 is configured as an inverted cup-shaped member atop base 32 having a truncated top 34a, and having a cavity 35 which generally conforms to the shape of the envelope of the diode 36. Truncated top 34a is a generally planar surface serving as a vacuum pick-up area as does base lip surface 32a. Filter housing 34 is formed with a generally uniform wall thickness 34b for providing substantially uniform light transmission from the lamp 36 during operation.

Filter housing 34 is typically a translucent combination of silicone rubber and a desired amount of phosphor mixed therein whereby luminescent output is achieved upon stimulation by short wavelength energy of the diode 36. This stimulation by diode 36 acts upon body 34 functioning as a frequency converter up-shifting the blue light into longer wavelengths. The silicone rubber/phosphor mixture also acts to mix the blue light with the longer wavelength light to result in a light, typically a white color light, which can be shifted in color hue depending upon the quantity and type of phosphor mixed into the silicone rubber

The assembly 30 extends from the PC-Board, typically 7-12 mm, to provide a light emitting area displaced from the circuit board. This allows for emitted light to clear adjacent components As further discussed below, this clearance, combined with the silicone rubberphosphor mixture capability of providing a very even and diffuse light emission, is suitable for coupling to a light pipe or for lighting the back of automobile instruments with uniform lighting.

Base portion 32 is enlarged from housing 34 and is generally rectangular, or oblong, in configuration. It is formed having a peripheral generally planar lip surface 32a that serves as a vacuum pick-up surface for facilitating accurate placement of the assembly onto a substrate. The rectangular, or oblong, shape facilitates consistent mechanical orientation and handling. An open bottom permits access to cavity 35 for insertion therein of miniature LED 36. The perimeter of base 32 is configured to accept standard LED packages with the lead frame formed into 90 degree angles to create a surface for soldering to a PC-Board.

The cavity 35 is formed for receiving LED 36 with the leads 36a and 36b bent into the mounting plane to enable the leads to be utilized for mechanical and electrical bonding to the substrate. This eliminates additional attachments such as metal tabs or feet to which the leads would be bonded, thus simplifying the lamp construction while improving reliability by fewer components, that is, two components in this embodiment.

As shown in FIG. 4, two generally V-shaped cutouts 32b and 32c are removed on opposite edges on the long axis of body portion 32. Leads 36a, 36b are directed outwards into cutouts 32b and 32c, respectively, to terminate within the outer limits of the cutouts thereby providing for protection of leads 36a, 36b during handling of the assembly. As can be verified visually through the cutouts, and consistent with industry standards, leads 36a, 36b are of different lengths, the cathode being shorter, to provide polarity indication and for correct placement of the assembly on the printed circuit board.

Leads 36a, 36b are visible through the cutouts 32b and 32c, respectively, to thereby provide visual inspection means for verifying soldering integrity of the leads. The underside of housing 34 is provided with two pair of feet 37 and 38 formed as arcuate sections at opposite sides of the cutouts 32b and 32c, respectively Feet 37 and 38 provide spacing between the substrate (not shown) and the lamp mount assembly 30 for enabling post soldering cleaning of residual material.

Leads 36a, 36b of the lamp are directed outwards into the respective cutouts in a plane generally parallel to the plane of the flange portion of the base portion at the underside thereof. The leads terminate within the outer limit of the cutout to provide protection for the lead during mechanical, as well as manual, handling of the assembly, yet are exposed at the periphery of the base 32 to allow for soldering. The cutouts 32b and 32c provide means for visual inspection of the lead-to-PC Board solder joint as well as providing radiant exposure of solder re-flow heat.

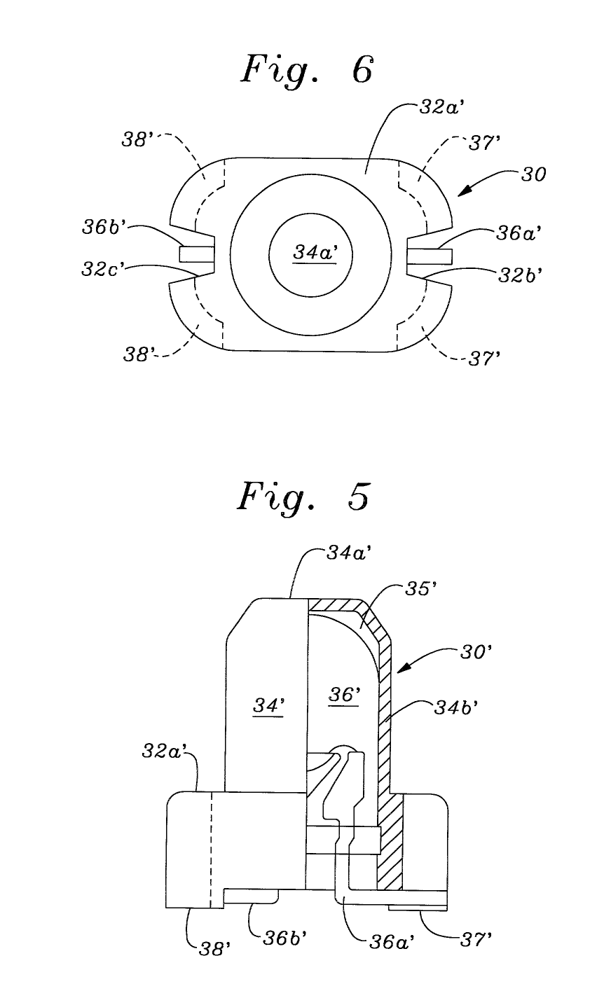

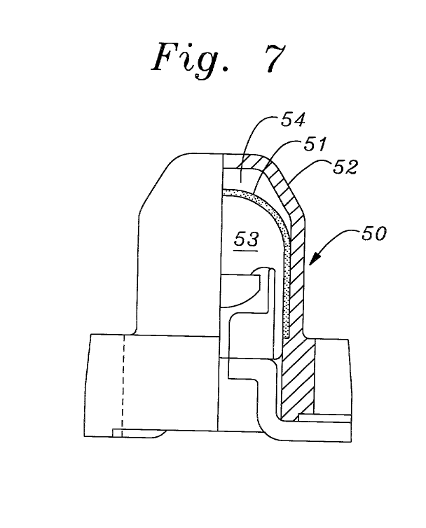

FIG. 5 depicts, in a side elevational view, partially in section, and FIG. 6 depicts, in a top plan view, an alternative of the embodiment of the lamp assembly of FIGS. 3 and 4. The alternate embodiment is designed to accept a different LED package from the embodiment of FIGS. 3 and 4 The embodiment is similar in construction to that of FIGS. 3 and 4 except that the assembly is designed to accept a T-1¾ (T-5.0 mm) industry standard LED package instead of the T-1 (T-3.0 mm) package for which the configuration of FIGS. 3 and 4 is designed. In this embodiment, reference numerals for like parts bear the same numerals as the embodiment of FIGS. 3 and 4, and thus, a further detailed explanation thereof is unnecessary. The changed aspects will bear the same numerals followed by a prime (′). It is seen, however, that the configuration is more oblong than rectangular, and it is understood that the LED is a different industry package.

FIG. 7 depicts another embodiment of the surface mount lamp assembly of FIGS. 3 and 4 designed to reduce the cost associated with the phosphor used in the housing and/or to provide additional diffusing or filtering. Generally designated 50, the difference is that the assembly embodies a smaller phosphor filled silicone element 51, within the cavity 54 of housing 52, that covers the LED 53. The housing is typically of clear or pigmented silicone rubber to provide filtering of the light produced by the phosphor and the LED. Otherwise, the embodiment is similar to that of FIGS. 3 and 4, and thus, a further detailed explanation is unnecessary

In the surface mount lamp assemblies according to the present invention, the assemblies are quite small in dimension. Typically, by way of example, the outer diameter of the filter would be about 5 mm, with the overall height of the assembly about 10 mm. The width of the filter would be somewhat between 8 and 10 mm. Such assemblies, while quite small, need not be fragile if constructed in accordance with the embodiments of the present invention

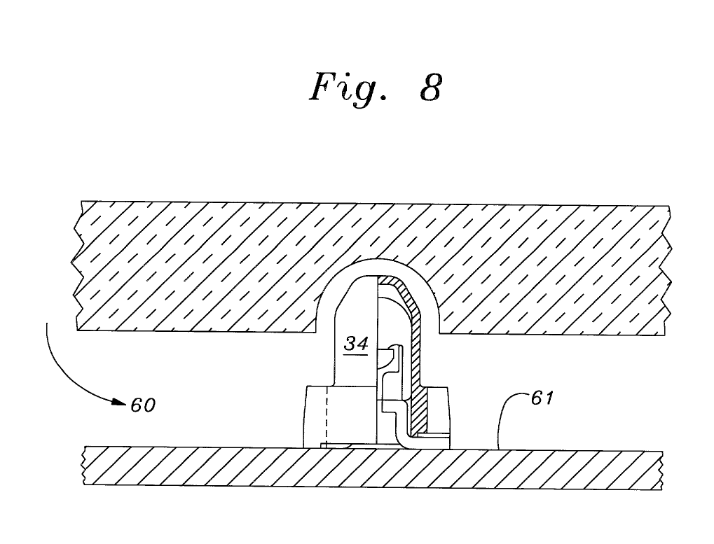

FIG. 8 depicts a side elevational view, partially in section, of the lamp assembly substantially as shown and described in FIGS. 3 and 4, adaptable to a light pipe 60. The design of the housing 34 of the invention provides a light emitting area that is extended from the PC-Board 61, the emitting area typically 7-12 mm from the circuit board surface. This allows for light emitted from the housing to clear adjacent components and provide a light source which is easily adaptable to light pipe 60 to spread the emitted light to the areas of the device that requires illumination. The characteristics of the silicone-phosphor mix of the housing provides a light diffusing medium in addition to its wavelength converting properties, thus providing an even and diffuse light emission suitable for coupling to a light pipe, or, for lighting an automobile instrument panel with uniform lighting. Varying the thickness of the silicone/phosphor member and the quantity of phosphor added to the mix can vary the diffusion.

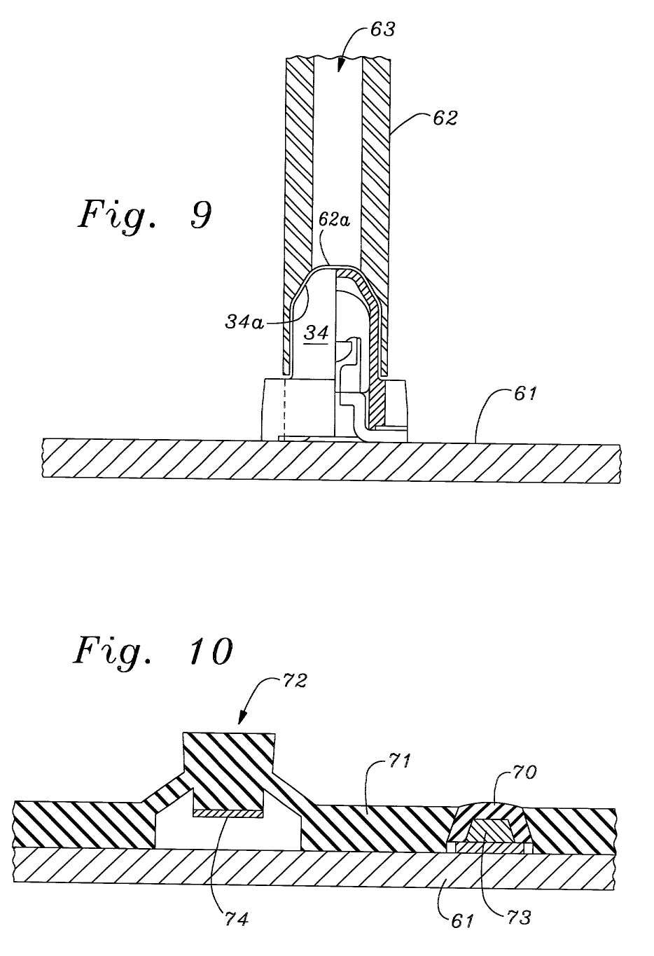

FIG. 9 depicts, in a side elevational view, partially in section, the lamp assembly substantially as shown and described in FIGS. 3 and 4, adaptable for vacuum pickup. The use of light pipes often requires that the light emitting device be accurately placed on the PC-Board 61 to assure proper mechanical alignment with the light pipe. The long cylindrical upper portion of the lamp housing 34 can aid in aligning the part for placement in relation to the vacuum nozzle 62. Vacuum nozzle 62 can have an inner diameter of vacuum passage 63 that is slightly larger than that of the filter housing 34, or it may be configured to fit over the width of the integral rectangular silicone filter base 32 as shown in FIG. 4.

The housing 34 provides an excellent surface for vacuum sealing since the pliability of the silicone, or elastomer, housing 34 provides a surface that minimizes vacuum loss. The truncated conical shape of the top 34a of the housing further facilitates vacuum pickup as it matches the inner concave configuration 62a of the vacuum nozzle 62. Further, a centering occurs upon vacuum pickup via concentric fit of the conical shape of a portion of the housing 34 to that of the concave shape of a portion of the inside of the nozzle 62.

FIG. 10 depicts, in a side elevational view, a portion of a silicone rubber switch pad having phosphor mixed locations to act as a frequency converter when used in conjunction with a the blue or ultra violet light emitting diode. As shown, a phosphor mixed element 70 is inserted into a silicone rubber switch pad substrate 71, the tactile switch dome generally designated 72 and having contact 74 for activating the switch. Element 70 is positioned over diode 73 on the PC-Board 61. Diode 73 can be a surface mounted “chip” type light emitting diode that produces light in the blue or ultra violet range, the assembly producing a diffuse low profile light source that can provide various colors of light.

While there have been shown and described preferred embodiments, it is to be understood that various other modifications may be made within the scope of the invention.

What is claimed is:

1 A light emitting assembly comprising:
a translucent component having silicone rubber mixed with phosphor; and
a light emitting diode to stimulate said translucent component to produce a light that can be shifted in color hue by the quantity and type of phosphor mixed with said silicone rubber.

2. The assembly according to claim 1 wherein said light emitting diode emits light taken from the group of blue light and ultra violet light.

3. The assembly according to claim 2 wherein said translucent component has light wavelength converting characteristics for cooperating with the stimulating wavelength of said light emitting diode to produce light with wavelength components longer than said stimulating wavelength of said light emitting diode.

4. The assembly according to claim 3 wherein said assembly is a surface mount device for mounting to a substrate;
said translucent component is a housing having a cavity therein for receiving said diode,
said housing configured as an inverted cup-shaped member mounted onto and integrally formed with an enlarged base portion peripherally extending from said cup-shaped member;
said diode has at least two leads extending from said cavity; and
said enlarged base portion includes diametrically opposed cut outs, said leads being formed to extend into the area of said cut outs for enabling attachment of said leads to substrate pads for providing electrical and mechanical connection to said substrate.

5. The assembly according to claim 4 wherein said base portion is rectangular in cross-section, is provided with spacing means on the surface adjacent the opening of said cavity, and said cut outs are generally V-shaped and positioned along the major axis of the rectangle, the lead associated with each cut out terminating within the outer limit of the cut out to provide protection for said lead during handling of the assembly.

6. The assembly according to claim 5 wherein said inverted cup-shaped member of said housing has a truncated top surface and said base includes a flat top surface, each such surface providing a pick-up surface for vacuum type tools.

7. The assembly according to claim 5 wherein said wherein said leads are of different lengths providing polarity indication, and said “V” shaped cut outs are configured to provide visual access to said leads for polarity verification, for visual inspection of lead-to-substrate solder joint, and for radiant exposure of solder re-flow heat.

8. The assembly according to claim 3 wherein said diode is surface mounted to a P-C Board and said translucent component is inserted over said diode as part of a switch pad substrate, the combination cooperating to provide a low profile diffused light source for an illuminated switch

9. The assembly according to claim 8 wherein said diode is a surface mounted “chip” type light emitting diode that produces light taken from the group of blue and ultra violet

10 A light emitting assembly comprising a housing formed of a translucent elastomer having a cavity containing a light emitting diode, said housing having light wavelength converting characteristics for cooperating with the stimulating wavelength of said light emitting diode to produce light with wavelength components longer than said stimulating wavelength of said light emitting diode.

11. The assembly according to claim 10 wherein said housing further has mixing characteristics for cooperating with the stimulating wavelength of said light emitting diode to provide a light which can be shifted in color hue depending upon the quantity and type of phosphor mixed into the silicone rubber.

12 A light emitting assembly for mounting to a substrate, said assembly comprising
a light emitting diode having at least two leads extending therefrom;
a housing including a cavity formed therein configured for receiving said diode with the leads extending from the opening thereof, said housing having an inverted cup-shaped upper portion mounted onto and integrally formed with an enlarged base portion extending from said cup-shaped portion;
said housing formed of translucent silicone rubber mixed with phosphor; and
said light emitting diode emits light taken from the group of blue light and ultra violet light and stimulates said housing to produce a light that can be shifted in color hue by the quantity and type of phosphor mixed with said silicone rubber.

13. The assembly according to claim 12 wherein said translucent component has light wavelength converting characteristics for cooperating with the stimulating wavelength of said light emitting diode to produce light with wavelength components longer than said stimulating wavelength of said light emitting diode.

14. The assembly according to claim 12 wherein said enlarged base portion has diametrically opposed cut outs, said leads being formed to extend into the area of said cut outs for enabling attachment of said leads to substrate pads for providing electrical and mechanical connection to the substrate; and
wherein said base portion is substantially rectangular in cross-section and is provided with spacing means on the surface adjacent the cavity opening.

15. The assembly according to claim 12 wherein said inverted cup-shaped member of said housing has a truncated top surface and said enlarged base includes a peripheral generally planar lip surface, each such surface providing a pick-up surface for vacuum type tools

16. The assembly according to claim 5 wherein said wherein said leads are of different lengths providing polarity indication, and said cut outs are of a generally “V” shaped configured to provide visual access to said leads for polarity verification, for visual inspection of lead-to-substrate solder joint, and for radiant exposure of solder re-flow heat

17. A light emitting assembly for an illuminated switch comprising:
a light emitting diode surface mounted to a P-C Board;
a silicone rubber switch pad substrate covering said diode;
a translucent component formed of silicone rubber mixed with phosphor inserted into said switch pad substrate over said diode, the combination cooperating to provide a low profile diffused light source for an illuminated switch; and
a tactile switch dome in said switch pad substrate having contact means for activating said diode.

18. The light emitting assembly of claim 17 wherein the light from said diode stimulates said translucent component to produce a light that can be shifted in color hue by the quantity and type of phosphor mixed with said silicone rubber.

19 The assembly according to claim 17 wherein said diode is a surface mounted “chip” type light emitting diode that produces light taken from the group of blue and ultra violet.

20 The assembly according to claim 17 wherein said translucent component has light wavelength converting characteristics for cooperating with the stimulating wavelength of said light emitting diode to produce light with wavelength components longer than said stimulating wavelength of said light emitting diode.
